(19) United States
(12) Patent Application Publication
(10) Pub. No.: US 2006/0147067 A1
(43) Pub. Date: Jul. 6, 2006

(54) Method and apparatus for assuring satisfaction of purchasers of large format television monitors

(76) Inventor: Noel Lee, Las Vegas, NV (US)

Correspondence Address: LaRiviere, Grubman & Payne, LLP, P.O. Box 3140, Monterey, CA, 93942, US

(21) Appl. No.: 11/029,032

(22) Filed: Jan. 3, 2005

(51) Int. Cl. H04R 5/02; H04R 29/00; H04R 1/02

(52) U.S. Cl. 381/306; 381/58; 381/332

(57) ABSTRACT

A surround sound system and method system to educate and guide the purchaser of a large format television receiver 11 to realize the expectation of recreating the music/movie experience in the home. The method includes demonstration of what good sound reproduction sounds like, and the experience of good sound is applied to audio/visual experience. A conventional system 12 is then demonstrated to show the differences between the systems with a variety of program material supplied to maximize the differences between the systems a program for certification of locations and personnel is contemplated. The device includes the systems 11, 12 demonstrated and program materials.

### TECHNICAL FIELD

The present invention relates to large format television monitors and surround sound systems and methods. More particularly, the present invention relates to methods for assuring that purchasers of large format television systems will be satisfied with their purchase and be able to recreate movie experiences through the use of surround sound tower systems and methods.

### BACKGROUND ART

One of the fastest growing consumer products in the electronic field is large format television for home theater systems. Types of large format monitors include projection receivers, plasma monitors and other flat panel monitors. Such monitors are frequently but not always equipped with two low power speakers. The investment required of the consumer to purchase such monitors ranges from a low of $1500 for a low end projector to over $10,000 for a large plasma monitor. Frequently, consumers purchase a so-called home theater in a box system at the same time which includes small surround sound speakers combined with a DVD player/receiver. Customers who purchase such systems are often dissatisfied with the resulting experience when their expectations are based upon movie house experiences. The consumer often attempts to play music through such a system and is or will be disappointed that the experience is inferior to their old stereo system.

Installing a home theater system which recreates the acoustic experience of any given music or movie soundtrack is vital to meeting the electronic consumer's expectations. A system that is capable of recreating the music/movie experience in a home theater surround sound system typically comprises compact disc/digital video discs (CD/DVD) or super audio compact disk (SACD) players or changers, audio/visual (A/V) monitors, tuners, equalizers, headphones, satellite speakers, center channel speakers, woofers or subwoofers. This is often not appreciated by the average purchaser of a large format television receiver. A current need exists for a system to educate and guide the purchaser of a large format television receiver to realize the expectation of recreating the music/movie experience in the home.

### DISCLOSURE OF THE INVENTION

The present invention addresses the current needs for a system to educate and guide the purchaser of a large format television receiver to realize the expectation of recreating the music/movie experience in the home. The method first includes a demonstration of what good sound reproduction sounds like. Then the experience of good sound is applied to movie soundtrack experience. This procedure educates the purchaser of a large format television receiver as to exactly how to maximize reproduction of the movie experience in their own living room.

The first step is to refresh the audio memory of the purchaser of a large format television receiver as to what exactly good stereo music reproduction from a CD with a high quality surround sound system sounds like. The purchaser of a large format television receiver is next shown how much power is needed to recreate that sound. Next, the demonstration is repeated with a MP3 player. Once it is established to the purchaser exactly what good audio comprises, the purchaser of a large format television receiver is shown how the quality standards apply to reproduction of movies in a home theater. The purchaser of a large format television receiver is then shown the performance of a high quality home theater sound system in conjunction with a large format television receiver. The same experience is repeated with a home theater in a box and the purchaser of a large format television receiver is guided to conclude that the sound reproducing components of a home theater system are as important to the experience as the quality of the video display. The purchaser of a large format television receiver is next shown what components make this experience possible. Finally, the purchaser of a large format television receiver is given the opportunity to obtain and purchase such components.

The method may further include procedures for certification and training of personnel and quality standards for venues used in practicing the method. The method may also include procedures for setting up and conducting each of the experiences.

The apparatus of the invention includes suitable demonstration rooms and furniture for practicing the method. The apparatus further includes suitable audio/video equipment for practicing the method along with program material which demonstrates the strengths and weaknesses of various component combinations.

### BRIEF DESCRIPTION OF THE DRAWING(S)

For a better understanding of the present invention, reference is made to the below referenced accompanying Drawing(s). Reference numbers refer to the same or equivalent parts of the present invention throughout the several figures of the Drawing(s).

FIG. 1 is a perspective view of a first embodiment of a surround sound system apparatus, in accordance with the present invention.

FIG. 2 is a top plan view of the FIG. 1 embodiment, in accordance with the present invention.

FIG. 3 is a flow chart of the method in accordance with the present invention.

FIG. 4 is a Certified Dealer Window Decal.

FIG. 5 is a Certified Dealer Sticker.

FIG. 6 is a Certified Dealer Wall Certificate.

FIG. 7 is a Certified Presenter Card.

FIG. 8 is a Certified Presenter Certificate.

### MODES FOR CARRYING OUT THE INVENTION

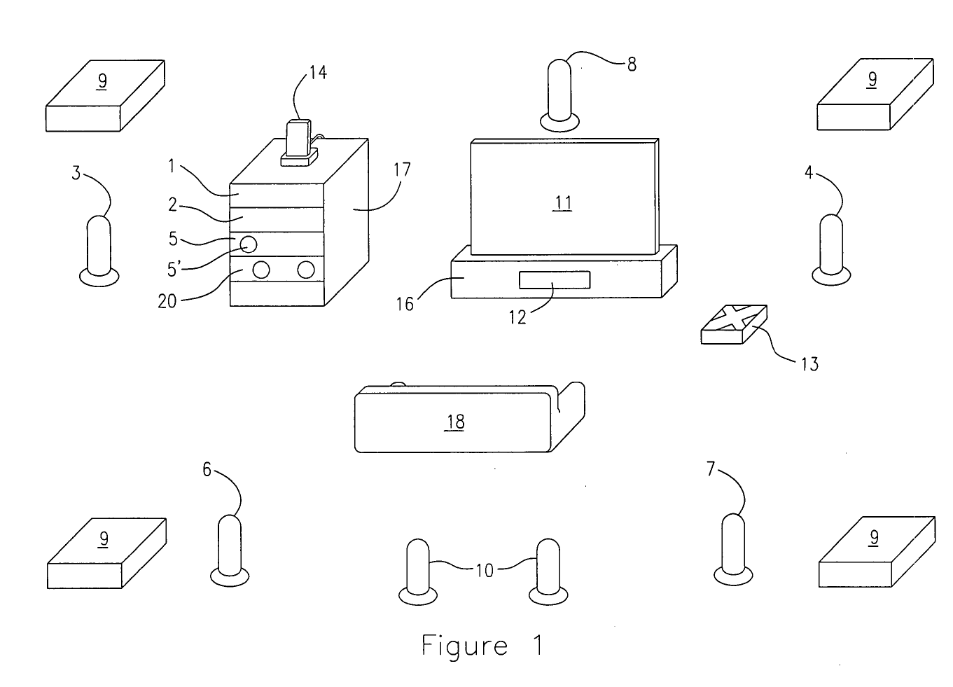

FIG. 1 is a perspective view of a first embodiment of a surround sound system apparatus, in accordance with the present invention. Suitable electronic audio/visual components are connected to perform the method. A DVD, Audio DVD/SACD player 1 serves as a source of audio and video signals. A suitable player 1 is distributed by Yamaha Electronics Corporation, USA of Buena Park, Calif. and designated model DVD-S2300. A mid-priced A/V receiver 2 with six channel audio inputs and six channel pre amp outputs is connected to player 1. A suitable receiver 2 is distributed by Denon Electronics, of Pine Brook, N.J. under the model designation AVR3803. Four side channel speakers 3, 4, 6 and 7 are connected to the side channel outputs of receiver 2. The connection is by way of a power amplifier 5 with a rapidly responding watt meter 5′. Suitable commercial power amplifiers for power amplifier 5 include those distributed by Monster, LLC of Las Vegas, Nev. under the trademark Monster Power® such as Models MPA 2250 and MPA 3250 with each speaker using a single channel of amplifier 5. Suitable side channel speakers 3, 4, 6, and 7 include those distributed by M-Design of Brisbane, Calif., designated as Eleganza Streamline Tower 8400. It is important that side channel speakers 3, 4, 6, and 7 be identical. A center channel speaker 8 is connected to the center channel output of receiver 2 by way of power amplifier 5. A suitable center channel speaker 8 includes that distributed by M-Design of Brisbane, Calif., designated as Eleganza Streamline Surround 3600. At least one and preferably four powered subwoofers 9 are connected to the subwoofer output(s) of receiver 2. Suitable subwoofers 9 include those distributed by M-Design of Brisbane, Calif. designated as Eleganza Godfather Subwoofer 1500. A 42-inch or larger Plasma Screen Monitor 11 is connected to the video outputs of receiver 2. A suitable Plasma Screen Monitor 11 is distributed by Pioneer Electronics (USA) Inc. of Long Beach, Calif. under the designation PDP-5040HD. A high quality home theater in a box system 12 is also situated in the same room. A suitable home theater in a box system 12 is sold by Sony Electronics e-Solutions Company, LLC of Woodcliff Lake, N.J. A game player 13 is further connected to Plasma Monitor 11 and receiver 2. A suitable game player 13 is distributed by The Microsoft Corporation of Redmond, Wash. under the model designation X-box. A MP-3 playback device 14 is also connected to the inputs of receiver 2. MP3 play back device 14 may be any device that plays digital audio files including (MP2, MP3, AAC, WMA, Wav, and ogg vorbis files) and is not limited to the MP3 format. Suitable MP-3 play back devices 14 include the i-Pod device distributed by Apple Computer of Cupertino, Calif., which plays AAC, MP3 and Wav files. An alternative MP3 playback device is a personal computer (PC) with suitable software such as iTunes also by Apple Computer of Cupertino, Calif., which allows playback of streaming audio over the Internet in addition to digital audio file playback. A suitable plasma stand 16 and equipment rack 17 are required to house the various components. Comfortable furniture 18 should be provided for seating the purchaser of a large format television receiver. The preferred couch for furniture 18 is distributed by Monster Cable Products, Inc. of Brisbane, Calif. under the trademark Action Couch™ and includes transducers and amplifiers for delivering exciting vibrations from any movie. To ensure the best possible sound, all components should receive their power from a power conditioner 20. Power conditioner 20 receives “polluted” power from a wall outlet (not shown). Wall socket power is “polluted” because it varies in voltage on a random basis and contains high frequency components which can change the sound produced from each of the other components. Suitable power conditioner 20 components include voltage stabilizers exemplified by the AVS 2000 voltage stabilizer distributed by Monster, LLC of Las Vegas, Nev. under the trademark Monster Power® and power cleaners such as the HTPS 7000 distributed by Monster, LLC of Las Vegas, Nev. under the trademark Monster Power®. Suitable software for performing the method is also required to be inputed to each of the various signal sources.

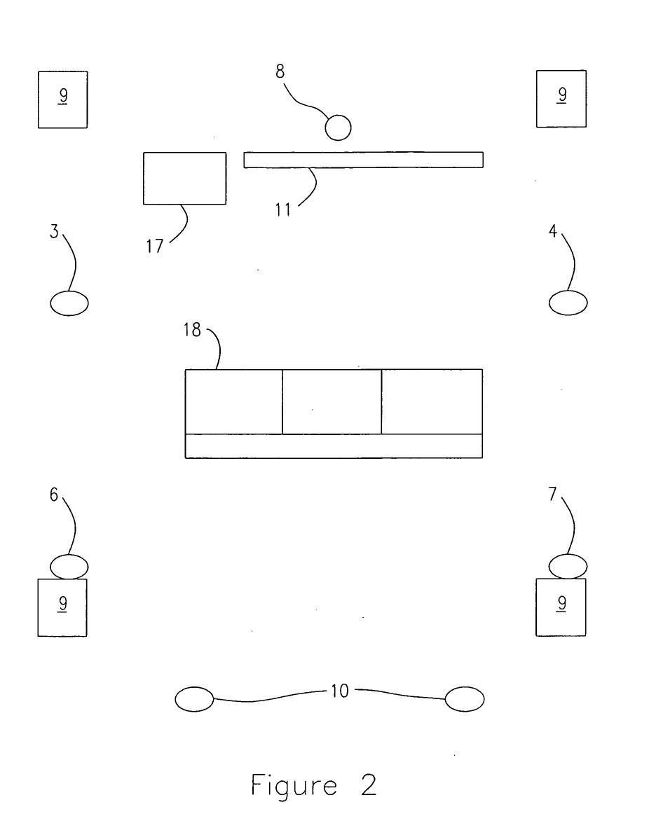

FIG. 2 is a top plan view of the FIG. 1 embodiment, in accordance with the present invention. This view makes clear the placement of speakers 3, 4, 6, 7 and 6. Front left channel speaker 3 is to the left and in front of furniture 18. Front right channel speaker 4 is to the right and in front of furniture 18. A center channel speaker 8 is connected to the center channel output of receiver 2 by way of power amplifier 5 and is directly in front of furniture 18. Left rear channel speaker 6 is to the left and into the rear of furniture 18. Right rear channel speaker 7 is to the right and to the rear of furniture 18. If it is desired to demonstrate so called 7.1 channel sound, two additional speakers 10 are situated directly behind furniture 18. 7.1 channel sound as used in THX® is a bit of a misnomer as both speakers 10 are connected to a common channel. Plasma Screen Monitor 11 is located on suitable plasma stand 16 directly in front of furniture 18.

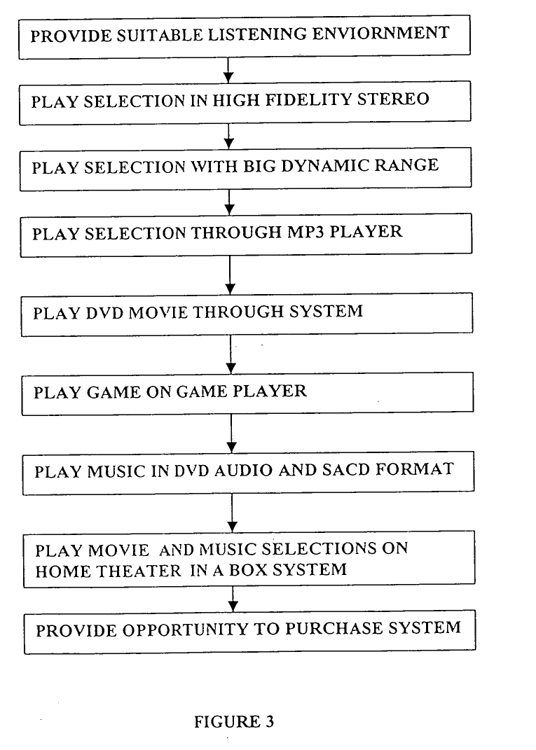

FIG. 3 is a flow chart of the method in accordance with the present invention. In the present method, the first step 100 is that of providing a suitable environment such as that shown in FIGS. 1 and 2. The second step is that of providing a Music Experience in conventional stereophonic sound. The preferred method to accomplish this step is to insert a high quality CD into player 1. The CD is preferably vocal music such as the James Ingram recording of Maria from West Side Story by Lennard Bernstein. A selection such as this will clearly illustrate the phenomena of the “phantom channel” where the music appears to be coming from a position intermediate between the two speakers which are actually playing. This clearly illustrates the concepts of “soundstage” and accurate image where the ear can determine the position of individual instruments in the recording. The purchaser of a large format television receiver then observes the power required to reproduce the louder sections of the recording. The procedure is repeated with a selection that has a particularly large dynamic range. A suitable recording used in one particular embodiment is, I Can't Stand the Pain by Jason Weaver. The purchaser of a large format television receiver will note that the peak power required to produce the louder portions is over 300 watts.

The procedure is then repeated with a playing of an identical recording through MP3 play back device 14. The purchaser of a large format television receiver will note that there is very little difference between the MP3 and the CD when played through the above configuration.

The next step is to provide the movie experience with a quality surround system. This step is accomplished in this embodiment by playing a disk on player 1 containing portions of movies. The chosen source is a demonstration DVD disk produced by THX Ltd. of San Rafael, Calif. entitled THX® ULTIMATE DEMO DISC. The opening of the disk includes a picture of the THX logo which shatters with a fanfare. During this demonstration the meters on amplifiers 5 will go from 1 to 350 watts. Next, the demonstration is repeated with a clip from an actual movie. A movie that this embodiment has been successfully practiced with is the opening sequence of Walt Disney production of ATLANTIS THE LOST CONTINENT, distributed by Buena Vista of Anaheim, Calif. Again, the power meters on amplifier 5 will go to over 300 watts and the sound serves to draw the viewer into the movie.

The above experience continues with activation of game player 13. The purchaser of a large format television receiver experiences game play through the surround sound system.

The next experience is that of music reproduction through the system. The purchaser of a large format television receiver is made aware that large qualities of music have been remastered for DVD audio and SACD formats. A recording that the purchaser of a large format television receiver has likely heard many times is inserted into player 1 in either of these formats. In the embodiment being described the recording of Hotel California by the Eagles in DVD Audio format was used satisfactory. The purchaser of a large format television receiver is then asked if it sounds different from the other times they have heard the music. Next, the system is demonstrated by laying in player a recording that has an extremely large dynamic range. In the embodiment being described the recording of Tchaikovsky 1812 overture by Telearc designated as 1812 DVD-A track 1 in DVD Audio format was used satisfactory and asked to observe the power meters on amplifier 5. In this demonstration the power will go from 140 to 400 watts simultaneously on all five channels when the cannons fire.

The next experience is playing the same high dynamic range disk on the Home Theater in a box player 12. The purchaser of a large format television receiver is allowed to draw their own conclusions. It will be apparent that there is no real comparison possible between the two systems with the component system being clearly superior.

The final step in the process is showing and making available to the equipment to the purchaser of a large format television receiver. Details of each component of the system are explained to the purchaser of a large format television receiver, along with the function of each component and the effect of that component on the sound just experienced. The purchaser of a large format television receiver is then given the opportunity to purchase those components which they do not already own in order to experience the full audio/visual experience at their own home.

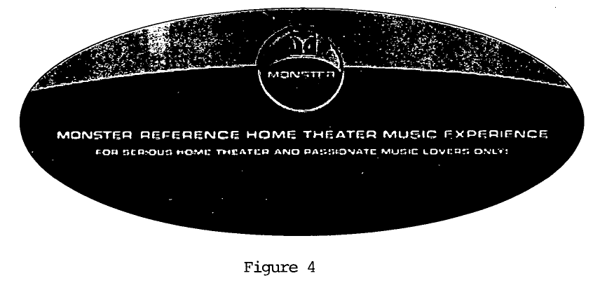

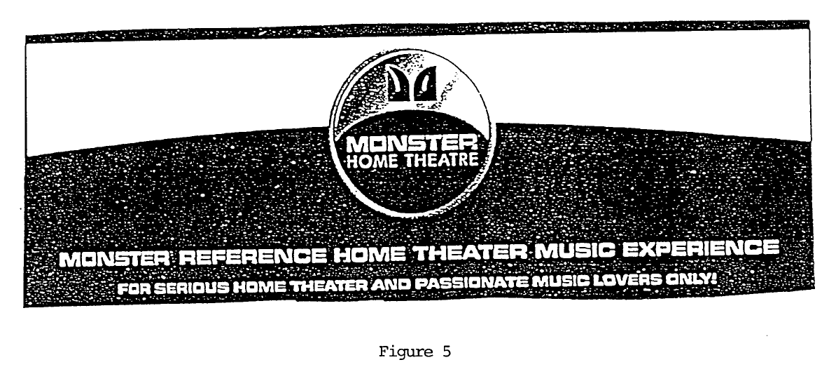

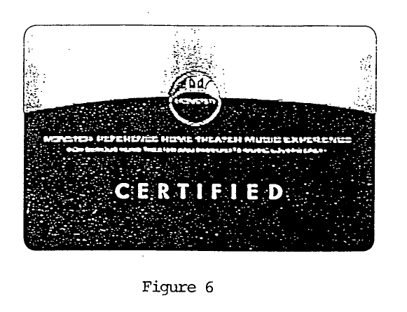

It is anticipated that the above process will be conducted on the premises of a retailer of audio/visual equipment. It may be considered to be an integrated sales and merchandising program implemented through a product program. In order to assure proper following of the method, a certification program for personnel and locations is contemplated. Certified dealers will be presented with a certificate FIG. 4, a window decal FIG. 5, and a sticker FIG. 6. In order to become certified, a dealer will have to have all of the materials necessary for the method on premises and have training scheduled for presenters of the method. In addition to apparatus above, the certified location will receive an experience guidebook which includes an introduction and background, a set up guide, an equipment and software list, system calibration instructions, demonstration record sheets, and equipment hookup steps.

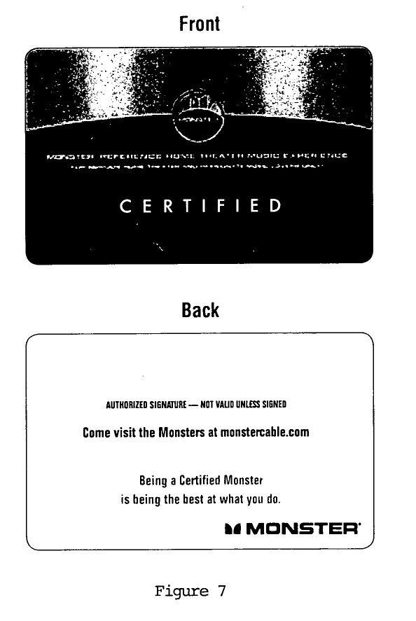

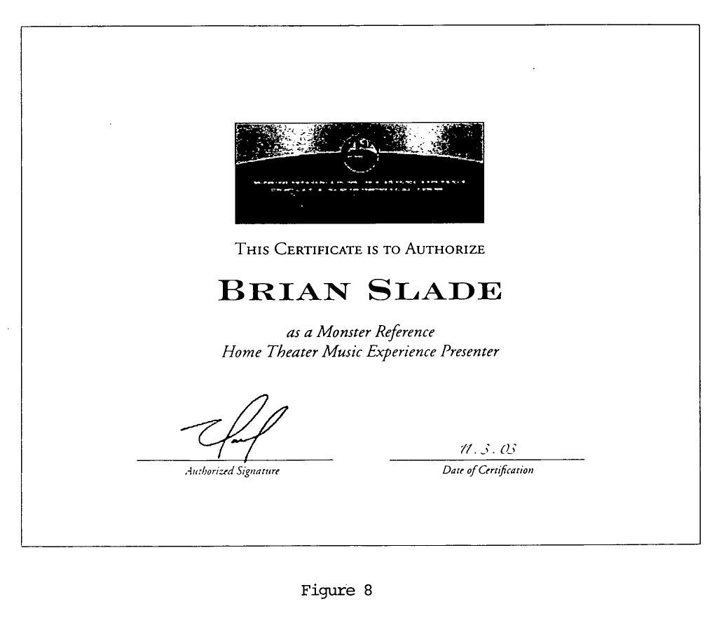

Similarly, presenters will be certified and given a card FIG. 7 and certificate FIG. 8 only when they have completed a training program. The training materials for the presenters will include a DVD instructing how to set up the equipment, a second DVD explaining how to present the method to a purchaser of a large format television receiver. Finally, another DVD will be a consumer co-presentation to be used when practicing the method.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, various changes and modifications in form, material, and fabrication detail can be made without departing from the spirit and scope of the inventions as set forth in the appended claims should be readily apparent to those of ordinary skill in the art. No claim herein is to be construed under the provisions of 35 U.S.C. § 112, sixth paragraph, unless the element is expressly recited using the phrase “means for.”

### INDUSTRIAL APPLICABILITY

The present invention applies industrially to surround sound systems and methods. More particularly, the present invention applies industrially to surround sound tower systems and methods. Even more particularly the present invention applies industrially to surround sound positioning tower systems and methods.

What is claimed:

1. A method for satisfying a purchaser of large format television monitors by adding a surround sound system, comprising the steps of:
demonstrating how music sounds through a surround sound system to a purchaser of large format television monitors; and
further demonstrating how the audio track of a audio/video recording sounds through a high quality surround sound system to a purchaser of large format television monitors; and
contrasting the demonstration and further demonstration with the sound through television monitor speakers and home theater in a box devices to a purchaser of large format television monitors; and
making available for purchase the high quality surround sound system demonstrated.

2. A method, as recited in claim 1, further comprising the step of certifying personnel for performing said demonstration, further demonstrating and contrasting steps.

3. A method, as recited in claim 1, further comprising the step of certifying locations for performing said demonstration, further demonstrating and contrasting steps.

4. A method, as recited in claim 2, further comprising the step of certifying locations for performing said demonstration, further demonstrating and contrasting steps.

5. A method, as recited in claim 1, further comprising the step of yet further demonstrating how an MP3 audio track sounds through a high quality surround sound system to a purchaser of large format television monitor.

6. A method, as recited in claim 1, further comprising the step of yet further demonstrating how Video Game audio sounds through a high quality surround sound system to a purchaser of large format television monitor.

7. A method, as recited in claim 1, wherein said surround sound system includes a voltage stabilizer and a power cleaner.

8. A method, as recited in claim 1, wherein said audio demonstration and said further demonstrating steps are performed with program material selected to exhibit the dynamic range of the high quality surround sound system to a purchaser of large format television monitor.

9. A method for satisfying a purchaser of large format television monitors by adding a surround sound system, comprising the steps of:
demonstrating how music sounds through a surround sound system, said surround sound system including a voltage stabilizer and a power cleaner with program material selected to exhibit the dynamic range of the high quality surround sound system to a purchaser of large format television monitors; and
further demonstrating how the audio track of a audio/video recording sounds with program material selected to exhibit the dynamic range of the high quality surround sound system through a high quality surround sound system to a purchaser of large format television monitors; and
contrasting the demonstration and further demonstration with the sound through television monitor speakers and home theater in a box devices to a purchaser of large format television monitors; and
yet further demonstrating how an MP3 audio track sounds through a high quality surround sound system to a purchaser of large format television monitor; and
still further demonstrating how Video Game audio sounds through a high quality surround sound system to a purchaser of large format television monitor; and
making available for purchase the high quality surround sound system demonstrated; and
certifying personnel for performing said demonstration, further demonstrating and contrasting step; and
certifying locations for performing said demonstrating, further demonstrating and contrasting steps.

10. A device for performing a method for satisfying a purchaser of large format television monitors by adding a surround sound system, comprising:
a high quality surround sound system with power output meters for demonstrating the performance of such systems on music and DVD signal sources; and
a surround sound system such as that supplied in a home theater in a box; and
program material selected to demonstrate the dynamic range of each system.

11. A device as in claim 10, further comprising a certification indication for indicating the selection of the location and personnel by the distributor of the high quality surround sound system selected from the group of stickers, decals, identification cards, wall certificates and certificates.

12. A device as in claim 10, further comprising voltage stabilizers and power cleans for supplying said surround sound system with clean stable power.

13. A device as in claim 10, further comprising a MP3 player for supplying said surround sound system with an audio signal source.

14. A device as in claim 13, wherein said MP3 player is an personal computer.

15. A device as in claim 10, further comprising a video game player for supplying said surround sound system with an audio signal source.

16. A device as in claim 10, wherein said surround sound system is capable of supplying at least 200 watts per channel into its speakers.

17. A device as in claim 10, wherein said surround sound system is capable of supplying at least 300 watts per channel into its speakers.

18. A device as in claim 10, wherein said program source includes vocal music for demonstrating the phantom channel phenomena.

19. A device as in claim 18, wherein said program source further includes selections in DTS and DVD audio.

20. A device as in claim 10, further comprising a certification indication for indicating the selection of the location and personnel by the distributor of the high quality surround sound system selected from the group of stickers, decals, identification cards, wall certificates and certificates:
a MP3 player for supplying said surround sound system with an audio signal source; and
a video game player for supplying said surround sound system with an audio signal source; and
further comprising voltage stabilizers and power cleans for supplying said surround sound system with clean stable power; and
wherein said program source includes vocal music for demonstrating the phantom channel phenomena.
